(19) United States
(12) Patent Application Publication
(10) Pub. No.: US 2011/0007319 A1
(43) Pub. Date: Jan. 13, 2011

(54) Arrangement for Determining the Reflectivity of a Sample

(75) Inventors: Nico Correns, Weimar (DE); Werner Hoyme, Gebstedt (DE); Felix Kerstan, Jena (DE); Thomas Keune, Jena (DE); Wilhelm Schebesta, Jena (DE)

Correspondence Address: FISH & RICHARDSON P.C. (BO), P.O. BOX 1022, MINNEAPOLIS, MN, 55440-1022, US

(73) Assignee: CARL ZEISS MICROIMAGING GMBH, Jena (DE)

(21) Appl. No.: 12/745,158

(22) PCT Filed: Dec. 10, 2008
(86) PCT No.: PCT/EP08/10454

§ 371 Date: Sep. 13, 2010

(30) Foreign Application Priority Data
Dec. 19, 2007 (DE) 102007061213.5

(51) Int. Cl. G01N 21/55

(52) U.S. Cl. 356/445

(57) ABSTRACT

The invention relates to an arrangement for measuring the reflectivity of the direct or scattered reflection of a sample (8), having a light source for separately lighting the sample (8) and of comparative surfaces. The arrangement comprises, in addition to the light source, preferably a reflector lamp (2), —a white standard (6), a black standard (7), and the surface of the sample (8) for embodying a measurement surface, wherein the exchange of the white standard (6), the black standard (7) and the sample (8) is provided in a prescribed sequence relative to each other, —means for measuring the intensity of the light reflected from an internal white surface (10) and for measuring the intensity of the light reflected from each measuring surface, and—an evaluation circuit designed for registering the measured intensity values and for linking the same mathematically to the reflectivity.

This invention pertains to a measurement configuration for the reflectivity of the direct or scattered reflection of a sample, having a light source for the separate illumination of a sample and comparative surfaces, an evaluation circuit designed to register the measured intensity values and for linking the same mathematically to the reflectivity.

Known from the state of the art are configurations to determine the reflectivity of sample surfaces, where a white standard surface and a black standard surface are used for comparison. A measuring scale determined at the beginning of the measurements is then used to calibrate the measuring equipment. The sought reflectivity lies between the benchmark values created by the white standard and the black standard and which are both measured at the same point as the sample.

The system parameters used to measure the reflectivity, change, however, because the intensity of the light source decreases, for example, or the sensitivity of the sensors required for the opto-electronic conversion of the received signals changes. In order to compensate for these changes the measuring scale must be repeatedly re-calibrated during the measuring process.

In the simplest case the sample is removed from the sample plane and replaced first with the white standard surface and then with the black standard surface or vice versa, and the measuring scale is redefined. Due to the relatively long time required for this type of calibration, this method is only usable in the laboratory. In process technology, these interruptions are disruptive and in many cases not even possible.

Indeed, there are known systems where the length of the interruption is reduced by calibrating the system only once at the beginning of a measuring process and later, after a specific time period, like one hour, for example, changes in the system parameters are compensated by pivoting additional surfaces—one for black and one for white—consecutively into the path of the measured light beam and using them as reference surfaces.

However, in order to pivot the white and black surfaces in and out of the path, the measuring processes must also be interrupted and can therefore not run continuously.

Furthermore, when using the measuring equipment of the known state of the art it cannot be excluded that light reflected by the surface of the sample radiates onto the sensors, thus preventing an accurate calibration.

Based on these facts the invention has the objective to provide an advanced configuration of the type described above in order to guarantee a more efficient determination of the reflectivity of samples and/or sample surfaces than with the current state of the art.

The invention solves this problem with a configuration comprising:
a) a light source for the separate illumination of a white surface and a measurement surface, wherein
   as embodiment of the measurement surface a white standard, a black standard, and the sample surface are provided, and
   an exchange of the white standard, the black standard, and the sample in a specified sequence is provided,
b) means to measure the intensity of the light reflected by the white surface and to measure the intensity of the light reflected by measurement surface,
c) an evaluation circuit designed to register the measured intensity values and to link them mathematically to the reflectivity.

The resulting benefit is the fact that the calibration can be repeated any number of times and in any sequence during the measuring process without significantly interfering with the measuring process as specific embodiments will explain in greater detail further down.

The white surface advantageously reflects the light diffusely and the light source, the white surface, and the means to measure the intensity are all enclosed inside the housing of a measuring head with the measurement surface being located outside the measuring head. The housing of the measuring head contains an area transparent for the light emitted by the light source and for the light reflected by the measurement surface. Since the white surface is integrated into the measuring head which is enclosed by the housing, the surface will in the following also be called “internal white surface”.

Provided as a means to measure the intensity is, at a minimum, one optoelectronic converter, which in connection with the invention described herein will be called a detector, and there are fiberoptic cables with upstream optical coupling devices to capture and transmit the light reflected by the internal white surface and the light reflected by the measurement surface to the detector.

In a preferred embodiment of the inventive configuration to capture of the light reflected by the measurement surface, multiple optical coupling devices, each followed by a fiberoptic cable, are configured radial-symmetrically around the measurement surface. This decreases the impact of structures onto the intensity measurement results, since the measurement is based not only on the light reaching the detector from only one reflecting direction. Therefore, the greater the number of couplings positioned around the measurement surface, the greater the compensation of structural impacts.

Inserted into the transmission path of the light reflected by the measurement surface and reaching the detector is a first shutter, and inserted into the transmission path reflected by the internal white surface and reaching the detector is a second shutter. Both shutters are provided and designed to either block or unblock the respective path of transmission.

In doing so, the measured intensity values are a function of the blocking or unblocking of the transmission paths as follows:

| | Transmission Path | Transmission Path |
|---|---|---|
| Intensity | ÜW1 | ÜW2 |
| I_{w} | Unblocked | Blocked |
| I_{wi} | Blocked | Unblocked |
| I_{D} | Blocked | Blocked |
| Iₛ | Unblocked | Blocked |
| I_{P} | Unblocked | Blocked |

with:
I₁ being the intensity of the light reflected by the white standard,
I_{wi} being the intensity of the light reflected by the internal white surface,
I_{D} being the intensity at the non-illuminated detector surface,
Iₛ being the intensity of the light reflected by the black standard, and
I_{P} being the intensity of the light reflected by the sample.

The thereby determined intensities allow the determination of a corrected reflectivity Rₚ in a manner described below on a sample.

Especially advantageous is a configuration where the first white standard surface is tilted toward the propagative direction of the light reflected by the measurement surface, preventing the light from hitting the internal white surface. This ensures that the result of the measured intensity I_{w} of the light reflected by the internal white surface cannot be falsified by the light reflected by the measured surface.

Furthermore advantageous is an internal white surface designed in the shape of a circular ring and several optical coupling devices, each of which are connected to a detector via a fiberoptic cable and a shutter, and positioned around the white surface centrically on an outer circle, and wherein the detectors respond to different wavelengths.

This design allows the use of the inventive configuration for an extremely broad range of wavelengths of illuminating light directed at the sample. Possible options are, for example, three detectors, with one being sensitive to the wavelengths of visible light (VIS), a second one for near infrared light (NIR), and the third for ultraviolet light (UV).

Also advantageous is the provision of a light source radiating light with a spectral-isotropic intensity distribution. This light source may be a reflector lamp, for example.

In the simplest case, the detector may be a photo diode and the evaluation circuit may be designed for the registration and linking of integral intensity values.

More accurate measuring results, however, can be achieved by a detector which is part of a spectrometer and exhibits a spatial receiving surface.

The spectrometer may be equipped with two light-entry gaps, whereby the light reflected at the internal white surface is transmitted to a first light-entry gap of the spectrometer and the light reflected at the measured surface is transmitted to the other light-entry gap of the spectrometer.

Inside the spectrometer, the light entering through the two light-entry gaps is directed onto the receiving surface, and the evaluation circuit is designed for the registration and linking of spectrally resolved intensity values.

In another preferred embodiment of the inventive configuration, the propagation direction of the light from the light source hitting the measured surface encloses an angle α>0 with the normal N_{M} of the measured surface, and the direction of the light propagating from the measured surface to the optical coupling devices encloses an angle of γ=α+β mit with the normal of the measured surface, with the angle β>0.

In this manner, the spatial distribution of the radiant intensity, for example, of a reflector lamp is used in such fashion that the axial and radial dependencies of the resulting radiant intensities on the sample or the sample surface mutually compensate each other in as large as possible a part of the operating distance, meaning the distance between the light source and the measured surface, resulting in a measurement of the reflectivity which is to the greatest possible extent independent of the operating distance.

The invention shall be explained below in greater detail based on a sample embodiment. The attached drawings show

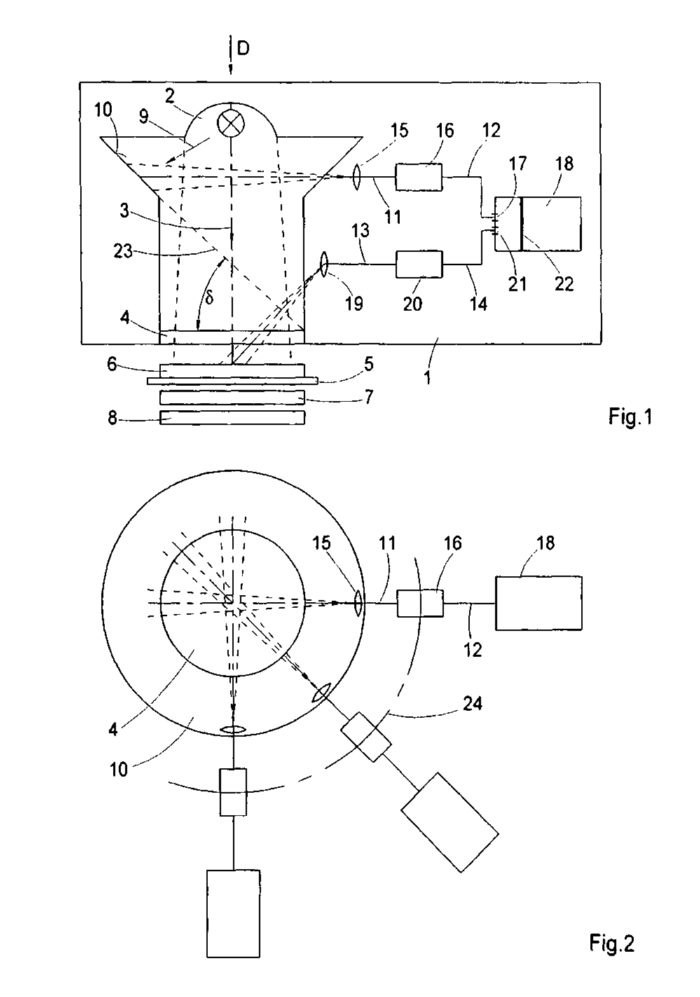

FIG. 1 a representation of the principal layout of the inventive configuration,

FIG. 2 a top view of the configuration of FIG. 1,

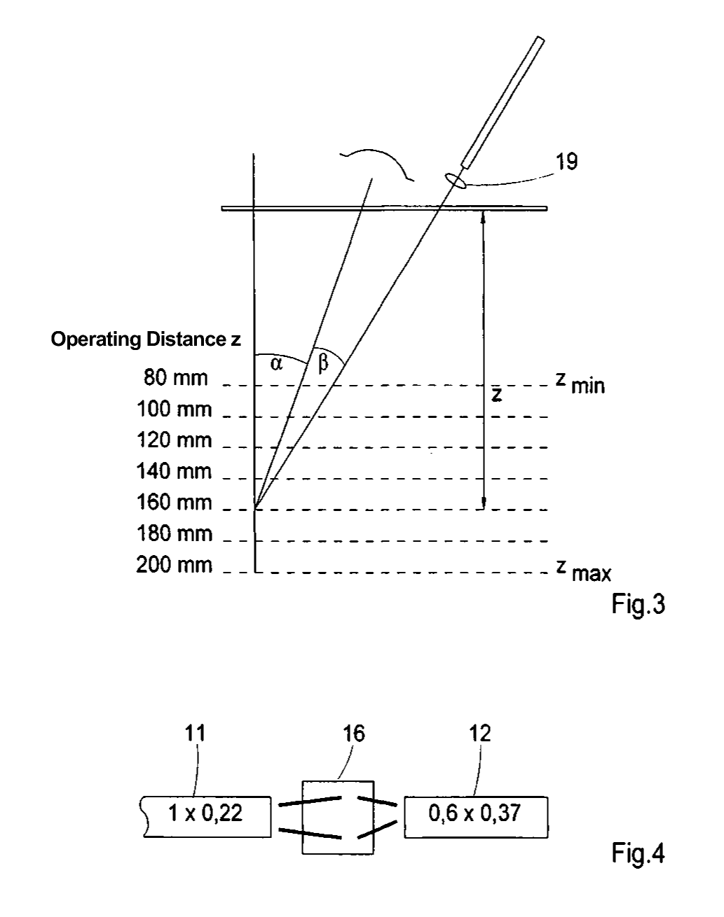

FIG. 3 a representation of advantageous propagation directions of the light from the light source hitting the measured surface, and the light propagating from the measured surface to the optical coupling devices relative to the normal of the measured surface,

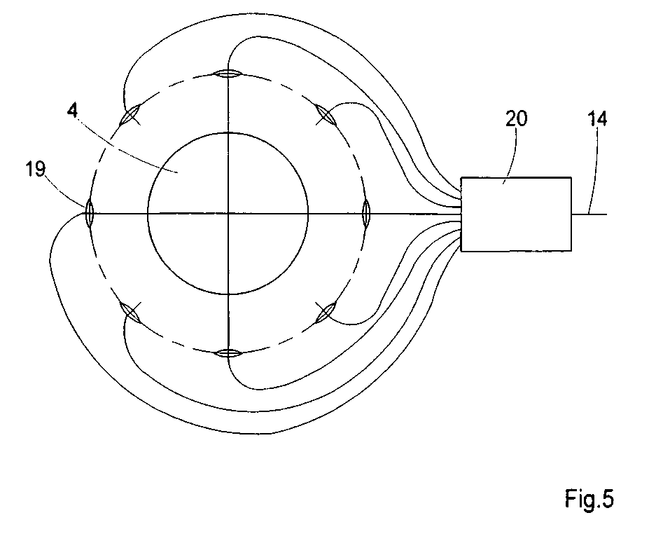

FIG. 4 a sample for the integration of a shutter into a transmission path of the measured or reference light to the spectrometer, realized via a fiberoptic cable,

FIG. 5 a sample for the configuration of several optical coupling devices radial-symmetrically to the measured surface,

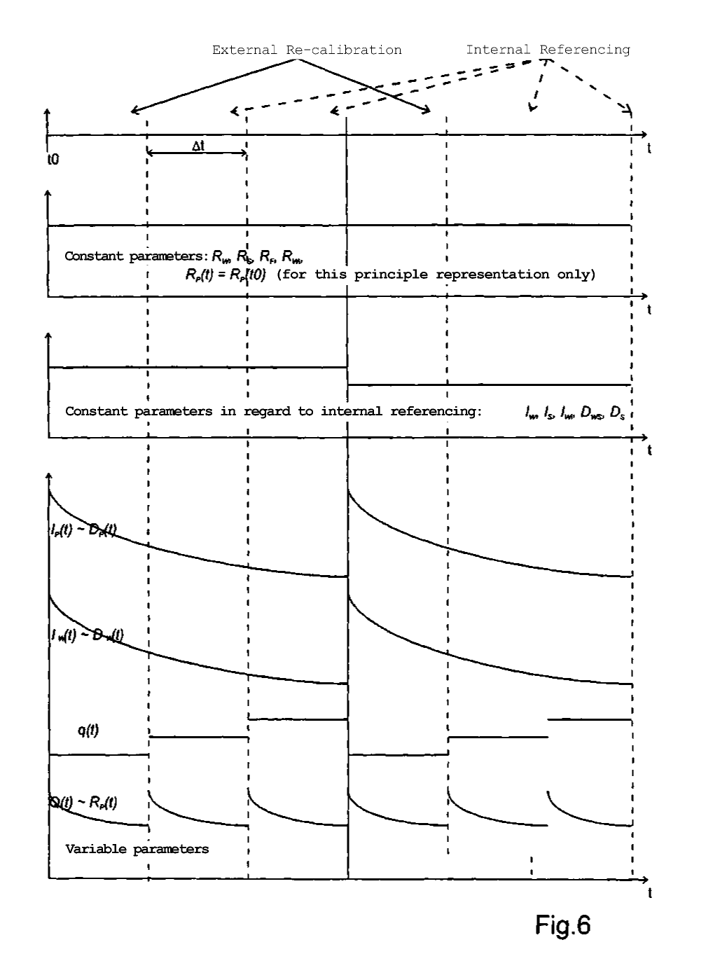

FIG. 6 a timing diagram for some measurement parameters to illustrate the principle of internal referencing.

FIG. 1 shows a reflector lamp 2 integrated into a measuring head with a first portion of radiation 3 directed through a measuring head window 4 onto a sample holding fixture 5.

The sample holding fixture 5 is provided and designed as a receptacle for a white standard 6, a black standard 7, and a sample 8, for which the reflectivity R_{P} shall be determined. The white standard 6, the black standard 7, and the sample 8 can be positioned on the sample holding fixture 5 and exchanged with each other in a specific sequence.

Inside the measuring head 1 a second portion of radiation 9 of the light coming from the reflector lamp 2 is directed onto a diffusely reflecting surface designed as standard measure of another white standard, in the following called internal white surface 10.

Further provided inside the measuring head 1 are fiberoptic cables 11, 12, 13 and 14. Upstream from fiberoptic cable 11 is an optical coupling device 15 which is positioned such that it captures the diffusely reflected radiation from the internal white surface 10 and couples it into the fiberoptic cable 11. The light coupled into fiberoptic cable 11 by optical coupling device 15 reaches the light-entry side of a shutter 16, whose light-exiting side is optically linked to the fiberoptic cable 12. The fiberoptic cable 12 is connected to a first entry gap 17 of a spectrometer 18.

Upstream from the fiberoptic cable 13 is an optical coupling device 19, which is provided and designed to collect the light reflected by a measurement surface, namely either by the white standard 6 on the sample fixture, the black standard 7 or by the surface of the sample 8, and which enters the measuring head 1 through the measuring head window 4.

The light coupled into the fiberoptic cable 13 by the optical coupling device 19 is forwarded inside the fiberoptic cable 13 to the light-entry side of a shutter 20 and enters through the fiberoptic cable 14 from the light-exiting side of the shutter 20. The fiberoptic cable 14 ends in a second entry gap 21 of the spectrometer 18.

The optical coupling device 15, the fiberoptic cable 11, the shutter 16 and the fiberoptic cable 12 form a transmission path for light to the spectrometer 18, which is reflected from the internal white surface 10, while the optical coupling device 19, the fiberoptic cable 13, the shutter 12 and the fiberoptic cable 14 form a transmission path for light reflected by the measured surface to the spectrometer 18.

Located inside the spectrometer 18 is the spatial receiving surface 22 of a detector, onto which the spectrum of the light entering through entry gap 17 as well as the spectrum of the light entering through entry gap 21 falls.

The signal outputs of the receiving surface 22 and the control inputs of shutter 16 and 20 are connected to a evaluation circuit (not shown) designed for the registration of the intensities of light reflected at the internal white surface 10 and for light reflected at the measurement surface, i. e. at the white standard 6, at the black standard 7, or at the sample 8 as well as for the mathematical linking of these intensity values.

The intensity values are measured dependent on the blocking or unblocking of the transmission paths as follows, whereby in this sample embodiment, spectrally measured, wavelength-dependent intensities shall be the basis:

| | Transmission Path | Transmission Path |
|---|---|---|
| Intensity Value | ÜW1 | ÜW2 |
| I_{W} | Unblocked | Blocked |
| I_{Wi} | Blocked | Unblocked |
| I_{D} | Blocked | Blocked |
| I_{S} | Unblocked | Blocked |
| I_{P} | Unblocked | Blocked |

with:
I_{w} being the intensity of the light reflected by white standard 6,
I_{wi} being the intensity of the light reflected by the internal white surface 10,
I_{D} of the intensity at non-illuminated detector surface,
Iₛ being the intensity of the light reflected by the black standard 7, and
I_{P} being the intensity of the light reflected by sample 8.

The following applies for the reflected intensities:

I_{W}=I·(R_{F}+R_{W}·[1−R_{F}]²)+I_{D}

I_{S}=I·(R_{F}+R_{S}·[1−R_{F}]²)+I_{D}

I_{P}=I·(R_{F}+R_{P}·[1−R_{F}]²)+I_{D}

I_{Wi}=Iᵢ·_{Wi}+I_{D}

with
I: Intensity of radiation portion 3 to the external measurement surface,
Iᵢ: Intensity of radiation portion 9 to the internal white surface 10,
R_{W}: Reflectivity of the white standard 6,
R_{Wi}: Reflectivity of the internal white surface 10,
R_{S}: Reflectivity of the black standard 7,
R_{P}: Reflectivity of the sample 8,
R_{F}: Reflectivity of the measuring head window 4,

Measuring sequence and determination of the reflectivity are provided as shown on the following sample:

At the time t0 at the beginning of a measuring process, an initial calibration is performed based on the white standard 6 and the black standard 7 being used as the measurement surface in a predefined sequence by measuring the intensity values I_{W}, I_{Wi}, I_{D} und I_{S}.

The measurements are made at the time t0 and at all later times t>t0 consistently with the integration time it=min(itₑ, itᵢ), wherein itₑ and itᵢ are the integration times at maximum signal strength of I_{W} and I_{Wi} at the time t0 of the initial calibration.

The intensity values at the time t0 of the initial calibration are calculated as follows:

Calculation of a difference D_{WS} (t0):

D_{WS}(t0)=I_{W}(t0)−I_{S}(t0)=I(t0)·[1−R_{F}]²·(R_{W}−R_{S})

Calculation of a difference D_{Wi} (t0):

D_{Wi}(t0)=I_{Wi}(t0)−I_{D}(t0)=Iᵢ(t0)·R_{Wi}

Calculation of a difference D_{S} (t0):

D_{S}(t0)=I_{S}(t0)−I_{D}(t0)=I(t0)·(R_{F}+R_{S}·[1−R_{F}]²)

By calculating the difference, the intensity I_{D} of the non-illuminated detector surface is stripped out from the measured intensities I_{W}, I_{S} und I_{Wi}.

The calculated differences D_{WS}, D_{S} and D_{Wi0} are preserved until the next external calibration.

The initial calibration is successfully completed when the intensities remitted by the respective external standards 6 and 7 as well as from the internal white surface 10 as intensity values I_{Wi}, I_{D}, I_{S} and I_{W} with the integration time it have been measured with the integration time it.

Measurement parameters at time t0 of the initial
calibration

| Measurement | Calculated |
|---|---|
| Parameter | Differences |
| it | |
| I_{W} | D_{WS} |
| I_{S} | D_{S} |
| I_{Wi0} | D_{Wi0} |
| I_{D} | |

During the subsequent long-time measurement of the sample material, an internal referencing procedure for the purpose of recalibration is performed during predefined time periods Δt in order to compensate for changes in system parameters and thus to obtain long-term stability.

For this purpose, only the intensity values for I_{Wi}(t) and I_{D}(t) as well as the intensity value I_{P}(t) at the times t=t0+Δt based on the sample 8 are measured.

The intensity values are mathematically linked as follows:

Calculation of a difference D_{Wi}(t):

D_{Wi}(t)=I_{Wi}(t)−I_{D}(t)=Iᵢ(t)·R_{Wi}

Calculation of a difference D_{P}(t):

D_{P}(t)=I_{P}(t)−I_{D}(t)=I(t)·(R_{F}+R_{P}(t)·[1−R_{F}]²)

While the calculated differences D_{WS}, D_{S} and D_{wi0} will be preserved until the next external calibration, the calculated differences D_{Wi}(t) and D_{P}(t) are updated at all times where t>t0.

After each internal referencing the calculation of the quotient

$$q ( t ) = \frac{{D}_{Wi 0}}{{D}_{Wi} ( t )} = \frac{I ( t 0 )}{I ( t )} = \frac{{I}_{i} ( t 0 )}{{I}_{i} ( t )}$$

is updated.

This quotient describes the relative change of the sensitivity and the measured intensity, which is the same at the internal and the external measuring location.

The recalibration is successfully completed when the current values of I_{Wi}(t), I_{D}(t) have been measured and incorporated into the calculation of the resulting value R_{P}(t) according to the formula below:

Parameters re-determined at every time t > t0

| | |
|---|---|
| Measured | Calculations |

| Parameters | Differences | Quotients |
|---|---|---|
| I_{P}(t) | D_{P}(t) | Q(t) (see below) |
| I_{Wi}(t) | D_{wi}(t) | q(t) |
| I_{D}(t) | | |

The differences determined in this manner and the quotient q(t) from internal referencing are at every time t>t0 mathematically linked into the quotient Q(t):

$$Q ( t ) = \frac{{D}_{p} ( t ) \cdot q ( t ) - {D}_{S 0}}{{D}_{WS 0}}$$

The Reflectivity R_{P}(t) of the sample 8 and/or the sample surface at the time t results from the quotient of the measurement values Q(t) and the certified values of the white and black standards R_{w} and Rs used in the initial calibration:

$$\begin{matrix}Q ( t ) = \frac{{D}_{P} ( t ) \cdot q ( t ) - {D}_{S 0}}{{D}_{WS 0}} \\ = \frac{{R}_{P} ( t ) - {R}_{S}}{{R}_{W} - {R}_{S}} ⇔ {R}_{P} ( t ) \\ = Q ( t ) \cdot ( {R}_{W} - {R}_{S} ) + {R}_{S} .\end{matrix}$$

When non-certified standards are used, R_{w}=1 and Rₛ=0 must be assumed. The measured reflectivities R_{P}(t) are then valid only for the particular specimens of the R_{w} and Rₛ standards and not independent of them.

In order to illustrate the principle of internal referencing, FIG. 6 shows a sample of a time diagram for some values.

From FIG. 1 can be furthermore obtained that the internal white surface 10 and the measured surface enclose an angle 8 which guarantees that the internal white surface is tilted towards the propagation direction of the light reflected by the measured surface such that this light cannot hit this internal white surface. In FIG. 1 this fact is suggested by the broken line 23.

The internal white surface 10 is configured on the inside of a truncated cone in the shape of circular ring, which is directed centrically to the propagation direction of the light emitted by the reflector lamp 2 to the measuring head window 4 and to the sample holding fixture 5. This becomes obvious in FIG. 2, which is a top view in direction D from FIG. 1 onto the truncated cone.

FIG. 2 furthermore shows a centrically configured perimeter 24 on which—optionally as part of a special design of the inventive configuration—other optical coupling devices, fiberoptic cables, and shutters, which are here not marked by separate reference numbers, and which are connected to spectrometers in the same manner as already described, are present in addition to the already described optical coupling devices 15 and 19, shutters 16 and 20, and in addition to the spectrometer 18, and wherein the additional spectrometers respond to different wavelengths.

As already explained, this embodiment of the inventive configuration allows the determination of the reflectivity for a very broad range of wavelengths of the light directed onto the sample 8 like VIS, NIR or UV, for example.

FIG. 3 refers to another advantageous embodiment of the inventive configuration. This embodiment utilizes the spatial radiant intensity distribution of the reflector lamp 2, which was used here, for example, such that the axial and radial dependencies of the radiant intensity resulting on the surface of the sample 8 compensate each other in as large a section of the operating distance z as possible, and the measured reflectivity value R_{P} is as much as possible independent of the operating distance z.

This is achieved in that the propagation direction of the light emitted by the reflector lamp 2 and hitting the respective measurement surface encloses an angle α>16° with the normal N_{M} of the measurement surface, and the propagation direction of the light reaching the optical coupling device from the measurement surface encloses an angle γ=α+β with the angle β>4°, with the apex of the angle γ being at z=100 mm.

Provided as optical coupling device 19 may be a lens with a focal length of f−5 mm.

The integration of the shutters 16, 20 into the fiberoptic cables 11, 12 and/or 13, 14 is shown in FIG. 4 on the sample of the shutter 16. A bundle fiberoptic cables with a diameter of 1 mm and a numerical aperture of NA=0.22 leads from the optical coupling device 15 to the shutter 16, and from shutter 16 to the entry gap 17 a fiberoptic cable 12 with a diameter of 0.6 mm and numerical aperture of NA=0.37.

FIG. 5 shows in viewing direction from the reflector lamp 2 onto the circular measuring head window 4 a sample of a configuration of several optical coupling devices radial-symmetrically to the radiation direction of the light onto the measurement surface. For reasons of clarity, here again, only the optical coupling device 19 has been referenced with a number. Located downstream from the other optical coupling devices, as well as for optical coupling device 19, is one fiberoptic cable each, in which light reflected from the measuring head window 4 into the measuring head 1 and collected by the optical coupling device is first forwarded to shutter 20, from where it reaches the joint fiberoptic cable 14 and the entry gap 21 on the receiving surface 22.

Part of the inventive idea are, of course, also embodiments in which the spectrometer has only one entry gap, the light paths are merged upstream of the spectrometer, followed by the light passing through this one entry gap and the respective spectrum being mapped onto the receiving surface 22.

The inventive configuration has the special advantage that it can be utilized to measure the direct reflection from a sample surface as well as the scattered reflection of a sample.

### LIST OF REFERENCE NUMBERS

1 Measuring Head

2 Reflector Lamp

3 Radiation Portion

4 Measuring Head Window

5 Sample Holding Fixture

6 White Standard

7 Black Standard

8 Sample

9 Radiation Portion

10 Internal White Surface

11, 12, 13, 14 Fiberoptic Cable

15 Optical Coupling device

16 Shutter

17 Entry Gap

18 Spectrometer

19 Optical Coupling Device

20 Shutter

21 Entry Gap

22 Receiving Surface

23 Broken Line

24 Perimeter

z Operating Distance

1. A configuration, comprising:
a light source configured to emit light
a first article having a reference white surface,
a measurement article comprising a white standard, a black standard, and/or a sample,
a detector configured to measure an intensity of light reflected by the reference white surface, the detector being configured to measure an intensity of light reflected by the measurement article, and
an evaluation circuit configured to register an intensity value measured by the detector, the evaluation circuit being configured to mathematically link the measured intensity value to reflectivity.

2. The configuration according to claim 1, wherein at least the reference white surface is diffusely reflecting.

3. The configuration according to claim 1, further comprising a housing, wherein the light source, the first article and the and the detector are inside the housing, and the measurement article is outside the housing.

4. The configuration according to claim 3ₛ wherein the housing includes a measuring head window which is transparent for the light emitted by the light source, the measuring head window also being transparent for the light reflected by the measurement article.

5. The configuration according to claim 1, wherein the detector comprises at least one optoelectronic sensor, and the configuration further comprises fiberoptic cables and optical coupling devices configured to transmit light reflected from the reference white surface to the detector.

6. The configuration according to claim 5, wherein at least some of the optical coupling devices are radial-symmetrically with respect to the measurement surface.

7. The configuration according to claim 5, further comprising:
a first shutter along a first transmission path of the light reflected from the measurement article to the detector,
a second shutter along a second transmission path of the light reflected from the reference white surface to the detector,
wherein the first and second shutters are configured to block or unblock the first and second transmission paths, respectively.

8. The configuration according to claim 7ₛ wherein the measurement of intensity value in dependence of the blocking or unblocking of the transmission paths is provided as follows:

| Intensity | Transmission Path | Transmission Path |
|---|---|---|
| Value | UW1 | UW2 |
| Iw | Unblocked | Blocked |
| Iwi | Blocked | Unblocked |
| ID | Blocked | Blocked |
| Is | Unblocked | Blocked |
| IP | Unblocked | Blocked |

with:
I_{w} being the intensity of the light reflected by the white standard,
I_{wi} being the intensity of the light reflected by the reference white surface,
I_{D} being the intensity when a detector surface that is not illuminated,
Iₛ being the intensity of light reflected by the black standard, and
Iₚ being the intensity of the light reflected by the sample.

9. The configuration according to claim 8, wherein the configuration is configured so that:
intensity values Iw, Iwi, ID and Is are used in a first an initial calibration and then
at predefined time periods tΔ, based on intensity readings IWi, ID and the intensity Ip, an internal reference via a sample measurement is provided for the purpose of re-calibrating the configuration and therefore for the compensation of changes in system parameters.

10. The configuration according to claim 5, wherein:
at least some of the fiberoptic cables upstream of first shutter are in the form of a bundle with a diameter of 1 mm and a numerical aperture of NA=0.22, and
at least some of the fiberoptic between the first shutter and the detector are in the form of a bundle with a diameter of 0.6 mm and a numerical aperture NA=0.37.

11. The configuration according to claim 1, wherein the reference white surface is tilted to a propagation direction of light reflected by the measurement article so that during use of the configuration light reflected by the measurement article does not hit the reference white surface.

12. The configuration according to claim 1, wherein:
the reference white surface is circular, and
on a centrically configured perimeter several optical coupling devices are positioned, each of which being connected to a detector via fiberoptic cables and a shutter, and
the detector is sensitive to different wavelengths.

13. The configuration according to claim 12, wherein the configuration comprises first, second and third detectors, the first detector being sensitive to visible light, the second detector being sensitive to near infrared range light, and the third detector being sensitive to ultraviolet light (UV).

14. The configuration according to a claim 1, wherein the light source is configured to emit light with a spectral-isotropic intensity distribution.

15. The configuration according to claim 1, wherein the detector is a photodiode, and the evaluation circuit is is configured to register and mathematical link integral intensity values.

16. The configuration according to claim 1, wherein:
the detector is an integral part of a spectrometer, and the detector has a spatial receiving surface,
during use, light reflected by the reference white surface is transmitted to a first entry gap of the spectrometer, and light reflected by the measurement article is transmitted to a second entry gap of the spectrometer,
inside the spectrometer, light entering through the first and second entry gaps is directed onto the spatial receiving surface, and
the evaluation circuit is configured to register and link spectrally resolved intensity values.

17. The configuration according to claim 1, wherein:
a propagation direction of light emitted by the light source that hits the measurement article encloses an angle a>0 with the normal of the measurement article, and
a propagation direction of light transmitted from the measurement article to the optical coupling device encloses an angle y=α+β with a normal of the measurement article, wherein β>0.

18. The configuration according to claim 17, wherein:
a distance z between the light source and the measurement article is between z=100 mm to 200 mm,
the angle a=α=16°,
the angle β=4°,
an apex of the angle y is z=100 mm, and
the configuration further comprises an optical coupling device comprising a lens with a focal length of f=5 mm.

19. A configuration, comprising:
an article having a reference white surface;
a holder configured to hold a white standard, a black standard and a sample so that, when the white standard, the black standard and/or the sample are present in the holder, the holder serves as a measurement article;
a light source configured so that a first portion of light emitted by the light source hits the reference white surface, and so that a second portion of light emitted by the light source hits the measurement article, the first portion of light being different from the second portion of light;
and
a detector configured to detect light reflected by the measurement article, and to detect light emitted by the measurement article.

20. The configuration of claim 19, wherein the holder is configured so that the white standard, the black standard and the sample are each independently exchangeable in the holder.
